(19) United States
(12) Patent Application Publication
(10) Pub. No.: US 2006/0183836 A1
(43) Pub. Date: Aug. 17, 2006

(54) Process for producing polysulfide compound and rubber composition containing the same

(76) Inventor: Wonmun Choi, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/549,131

(22) PCT Filed: Jan. 14, 2005
(86) PCT No.: PCT/JP05/00729

§ 371 Date: Sep. 16, 2005

(30) Foreign Application Priority Data
Mar. 1, 2004 (JP) 2004-056647

(51) Int. Cl. C08K 3/30

(52) U.S. Cl. 524/420; 528/189

(57) ABSTRACT

A production method of a polysulfide compound by reacting a dihalogen compound having the following formula (I) and a metal polysulfide having the following formula (II):
X—R—X (I)
wherein X is a halogen and R is a C₂ to C₂₄ alkylene group, which may have a substituent or a hetero atom, or is an aromatic alkylene group; and
M-Sx-M (II) wherein M is a metal of belonging to Group IA of the Periodic Table and x is an integer of an average 2 to 6 in an anhydrous solvent system.

### TECHNICAL FIELD

The present invention relates to a method for producing a polysulfide compound and a rubber composition containing the same. More specifically, it relates to a method for producing a polysulfide compound under an anhydrous reaction condition and a rubber composition containing the same.

### BACKGROUND ART

It is known to use reactions between dihalogen compounds and polysulfides of metals for the synthesis of cyclic sulfide compounds (see Japanese Patent Publication (A) No. 2002-293783). These cyclic sulfides are used, as a vulcanizing agent, in rubber compositions and improve the initial physical properties and durability of the vulcanized rubber over those of rubber compositions using ordinary sulfur vulcanization systems.

### DISCLOSURE OF THE INVENTION

As explained above, cyclic sulfides are useful as vulcanizing agents, but for practical application, since this synthesis method used an aqueous solution of a metal polysulfide, there were problems in the removal of the water after the reaction and the treatment of the wastewater from the reaction.

Accordingly, the object of the present invention is to provide a method for producing a polysulfide compound under an anhydrous reaction condition.

In accordance with the present invention, there is provided a method for producing a polysulfide compound comprising reacting a dihalogen compound having the following formula (I) and a metal polysulfide having the following formula (II):
X—R—X (I)
wherein X is a halogen and R is a C₂ to C₂₄ alkylene group, which may have a substituent or a hetero atom, or is an aromatic alkylene group; and
M-Sx-M (II)
wherein M is a metal belonging to Group IA of the Periodic Table and x is an integer of an average 2 to 6, in an anhydrous solvent system.

According to the present invention, since it is possible to synthesize a polysulfide compound under an anhydrous condition, the removal of the salts from the reaction product and the recovery of the polysulfide can be easily carried out. Further, since the treatment of wastewater is not required, the reduction of the production costs is also possible, which makes the present invention a method extremely high in practicality.

### BEST MODE FOR CARRYING OUT THE INVENTION

In this description and the claims, the singular forms should be deemed as including the plural form except, that the singular form is clear from the context.

The inventors engaged in research to produce a polysulfide compound under an anhydrous reaction condition and, as a result, found that, by reacting a dihalogen compound and an anhydrous metal polysulfide under an anhydrous reaction condition, a polysulfide compound can be produced with a good yield.

According to the present invention, a polysulfide compound is synthesized by reacting a dihalogen compound having the above-mentioned formula (I), wherein X is a halogen, particularly preferably a chlorine atom or bromine atom, R is an alkylene group including a substituted or unsubstituted C₂ to C₂₄ alkylene group or substituted or unsubstituted C₂ to C₂₄ oxyalkylene group, preferably a substituted or unsubstituted C₂ to C₂₄, more preferably C₄ to C₂₄ alkylene group or aromatic alkylene group with the above-mentioned metal polysulfide (II), wherein M indicates, for example, Group IA metal such as sodium, potassium, lithium, and x is an integer of an average 2 to 6, preferably an integer of 3 to 6, in an anhydrous solvent system (e.g., ether-based solvents, such as diethoxymethane, tetrahydrofuran (THF), 2-methyltetra-hydrofuran, crown ether, dimethoxyethane, diethyleneglycol dimethylether, triethyleneglycol dimethylether, diethyleneglycol dibutylether, propyleneglycol dimethylether, or aromatic hydrocarbon-based solvents such as benzene, toluene, xylene, so as to obtain a linear or cyclic polysulfide compound. The cyclic polysulfide compound is expressed by the following formula (III): 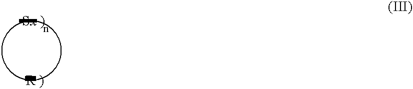
wherein, R is as defined above, x is an integer of an average 2 to 6 and n is an integer of 1 to 30.

According to the conventional method, as shown by the following reaction formula, for example, this was produced by reacting a dichloride and sodium polysulfide in an aqueous solution in mixed mutually insoluble solvents of toluene and water.

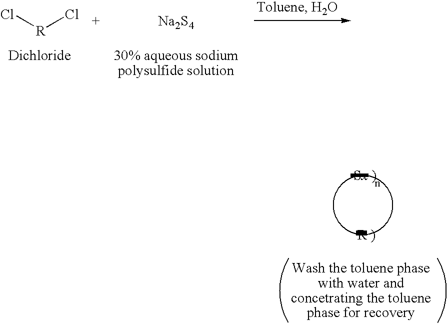

However, in this method, there was a large amount of water in the reaction system, and therefore, after the recovery of the reaction product after the end of the reaction (i.e., separation of the water) and the treatment of the separated wastewater were necessary, and therefore, this could not be said to have been that preferable practical method. Therefore, according to the present invention, as shown by the following two reaction formulae, sodium and sulfur may be used, as starting materials, or anhydrous sodium sulfate and sulfur used, as starting materials, to synthesize anhydrous sodium polysulfide, then for example a dichloride may added thereto and the resultant mixture was allowed to react in the anhydrous solvent system to synthesize the desired linear polysulfide or cyclic polysulfide. According to the method of the present invention, it is possible to recover the targeted compound by just removing the insolubles (produced salts) from the reaction product by filtration and concentrating the obtained organic phase.

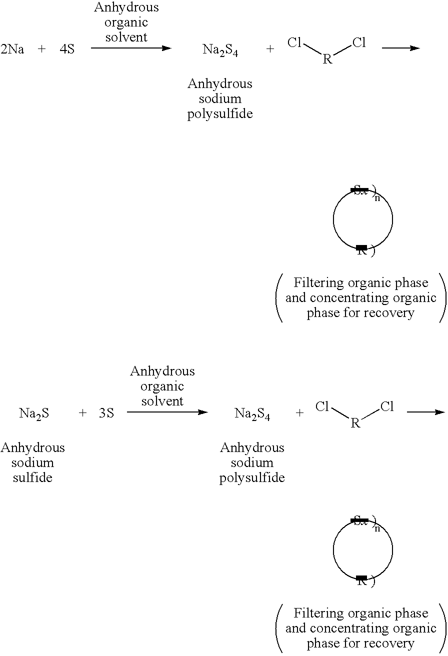

According to the present invention, it is possible to use an anhydrous metal polysulfide (II) such as anhydrous sodium polysulfide, as a starting material, but as explained above, it is possible to react Group IA metal such as sodium, or its sulfide with sulfur to produce, in the system, anhydrous metal polysulfide (II) such as anhydrous sodium polysulfide thereto and react thereto a dihalogen compound (I) to produce the desired polysulfide compound with a good yield.

The reaction between the alkali metal such as sodium and the sulfur or anhydrous sodium sulfide and the sulfur can be carried out by, for example, the method described in Japanese Patent Publication (A) No. 2000-103794. Specifically, this is effected, as shown in the Examples shown below. Next, when reacting the anhydrous metal polysulfide (II) such as anhydrous sodium polysulfide obtained above with the dihalogen compound (I), the reaction should be carried out in an anhydrous reaction system. Specifically, the reaction is carried out in an organic solvent selected from ether-based solvents such as dimethoxyethane, tetrahydrofuran (THF), 2-methyltetrahydrofuran, crown ether, dimethoxyether, diethyleneglycol dimethylether, triethyleneglycol dimethylether, diethyleneglycol dibutylether, propyleneglycol dimethylether, or aromatic hydrocarbon-based solvents such as benzene, toluene, xylene. In this case, the reaction is preferably carried out in a mixed solvent system of a solvent (A), in which the anhydrous metal polysulfide has a high solubility, and a solvent (B), in which the metal polysulfide has a low solubility, so as to produce the polysulfide compound. The reason for this is that, when performing the reaction in a solvent having a high solubility for the metal polysulfide, the polysulfide compound produced, in particular, the compound having the formula (III), becomes low in solubility, and therefore the recovery efficiency of the product becomes lower. Therefore, by carrying out the reaction in a mixed solvent system of a mixture of a solvent (A) having a high solubility for a metal polysulfide and a solvent (B) having a low solubility for a metal polysulfide whereby the polysulfide compound having a high solubility is produced and the polysulfide compound produced becomes easier to recover. If the mixing ratio of the solvent (A) and solvent (B) is (B)/(A)=0.1 to 10, there is no particular problem, but preferably (B)/(A) (weight ratio) is 0.5 to 10. As the solvent (A) having a high solubility for a metal polysulfide, the above-mentioned ether-based solvents are suitably used. Further, as the solvent (B) having a low solubility for a metal polysulfide, the above-mentioned aromatic hydrocarbon-based solvents are suitably used. By combining these solvents, it is possible to efficiently produce the polysulfide compound.

After the metal polysulfide is dissolved in such a solvent system, a solution, in which a dihalogen compound is dissolved in the same solvent system, is added thereto and the reaction for the production is carried out at a temperature of, preferably, room temperature to 100° C., for example, for 10 minutes to 24 hours. The addition method of the dihalogen compound is not particularly limited, but by adjusting the relative molar concentration (M) of the dihalogen compound with respect to the reaction solvent to be 10M or less at all times, a polysulfide compound, in particular a cyclic polysulfide compound having the formula (III) can be efficiently produced.

The polysulfide compound produced according to the method of the present invention can be used, as a vulcanization agent, in a rubber composition, instead of the conventional sulfur generally used or together with sulfur, whereby a rubber composition having excellent heat resistance etc. can be obtained, without affecting a detrimental effect to the production process.

The amount of the polysulfide compound compounded into the rubber composition of the present invention is not particularly limited, but to obtain the physical properties (e.g., tensile strength, modulus, etc.) of the vulcanized rubber required for practical application, it is preferably 0.2 to 20 parts by weight, more preferably 0.5 to 10 parts by weight, based upon 100 parts by weight of the vulcanizable rubber.

As the rubber components capable of compounding into the rubber composition of the present invention, any vulcanizable rubber usable for tire applications etc. may be mentioned. Typically, diene-based rubbers such as various types of natural rubber (NR), various types of aromatic vinyl-conjugated diene copolymer rubber such as a styrene-butadiene copolymer (SBR), various types of polyisoprene rubber (IR), various types of polybutadiene rubber (BR), acrylonitrile-butadiene copolymer rubber, styrene-isoprene copolymer rubber, styrene-isoprene-butadiene copolymer rubber, or butyl rubber, halogenated butyl rubber, ethylene-propylene-diene copolymer rubber, etc. may be mentioned. These may be used alone or in any mixtures thereof.

The rubber composition according to the present invention may contain, in addition to the above ingredients various additives generally used for tire applications and other general rubber applications such as, fillers such as carbon black, silica, various oils, an antioxidant, a plasticizer, various vulcanization accelerators, a silane coupling agent, This formulation may be mixed by a general method to obtain a composition to be used for vulcanization. The amounts of these additives may be made the conventional compounding amounts so long as the object of the present invention is not contravened.

### EXAMPLES

Examples will now be used to further explain the present invention, but the present invention is by no means limited in range to these Examples.

### Example 1

A three-necked flask equipped with a condenser and a thermometer was charged, under a nitrogen atmosphere, with 30% (mass) dispersion in toluene of 10 g (0.13 mol) of metal sodium, 8.3 g (0.26 mol) of sulfur, and 30 g dimethoxyethane, which were then reacted at 80° C. for 1 hour, then, at a temperature of 80° C., a solution of 12.2 g (0.065 mol) of 1,2-bis(2-chloroepoxy)ethane in 20 g of dimethoxyethane was dropwise added thereto over 2 hours and the result and mixture was further reacted at that temperature for 2 hours. After the end of the reaction, the organic phase salts or insolubles were separated by filtration, the salts or insolubles were washed with 20 g of toluene, then the organic phase was concentrated under reduced pressure at 90° C. to obtain the cyclic polysulfide shown in general formula (IV) in an amount of 14.1 g (yield 89%). 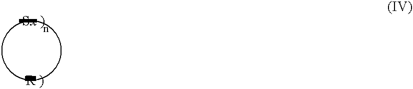
wherein R═(CH₂)₂O(CH₂)₂O(CH₂)₂

Average molecular weight (Mn): 1300

¹HNMR (270 MHz, CDCl₃) δ (ppm): 2.8-3.2 (4H, —S—CH₂—), 3.6-3.9 (8H, —O—CH₂—)

### Example 2

A three-necked flask equipped with a condenser and a thermometer was charged, under a nitrogen atmosphere, with 8 g (0.102 mol) of anhydrous sodium sulfide 9.8 g (0.306 mol) of sulfur, and 50 g of tetrahydrofuran (THF), which were then reacted at 80° C. for 1 hour, then, at a temperature of 80° C., a solution of 18.0 g (0.1 mol) of 1,2-bis(2-chloroepoxy)ethane in 20 g of THF was dropwise added thereto over 2 hours and the resultant mixture was further reacted at that temperature for 2 hours. After the end of the reaction, the organic phase salts were separated by filtration, then the organic phase was concentrated under reduced pressure at 90° C. to obtain the cyclic polysulfide shown in general formula (IV) in an amount of 22.7 g (yield 93%).

Average molecular weight (Mn): mixture of 230, 410, and 810

### Example 3

A three-necked flask equipped with a condenser and a thermometer was charged, under a nitrogen atmosphere, with 8 g (0.102 mol) of anhydrous sodium sulfide, 9.8 g (0.306 mol) of sulfur and 10 g of dimethoxyethane and 30 g of toluene, which were then reacted at 80° C. for 1 hour, then, at a temperature of 80° C., a solution of 18.0 g (0.1 mol) of 1,2-bis(2-chloroepoxy)ethane in 20 g of toluene was dropwise added thereto over 2 hours and the resultant mixture was further reacted at that temperature for 2 hours. After the end of the reaction, the salts of the organic phase were separated by filtration and the organic phase was concentrated under reduced pressure at 90° C. to obtain the cyclic polysulfide shown in formula (IV) in an amount of 21.5 g (yield 88%).

Average molecular weight (Mn): mixture of 230, 430, and 870

### Example 4

A three-necked flask equipped with a condenser and a thermometer was charged, under a nitrogen atmosphere, with 8 g (0.102 mol) of anhydrous sodium sulfide, 9.8 g (0.306 mol) of sulfur and 50 g of tetrahydrofuran (THF), which were then reacted at 80° C. for 1 hour, then, at a temperature of 80° C., a solution of 15.5 g (0.10 mol) of 1,6-dichlorohexane in 20 g of THF was dropwise added thereto over 2 hours and the resultant mixture was further reacted at that temperature for 2 hours. After the end of the reaction, the salts of the organic phase were separated by filtration and the organic phase was concentrated under reduced pressure at 90° C. to obtain the cyclic polysulfide shown in formula (V) in an amount of 20.2 g (yield 95%). 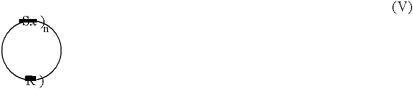
wherein R═(CH₂)₆

Average molecular weight (Mn): mixture of 230, 420, and 890

¹HNMR (270 MHz, CDCl₃) δ (ppm): 1.4-1.9 (8H, —CH₂—), 2.9-3.3 (4H, —S—CH₂—)

### Examples 4 to 6 and Comparative Example 1

According to each of the formulations shown in Table I, the ingredients other than the sulfur and cross-linking accelerator were mixed by a Banbury mixer for 5 minutes. Next, the mixture thus obtained was mixed with the sulfur and cross-linking accelerator by open rolls to obtain a rubber composition. The rubber composition thus obtained was pressed to cross-link at 160° C. over 20 minutes. The vulcanizate thus obtained was used for evaluation of the initial values of the physical properties and the values after heat aging at 100° C. for 72 hours. The test methods were as follows. The results are shown in Table I.

Test Method

100% modulus (MPa): Measured based on JIS K6251 (Dumbbell No. 3)

TB (strength at break) (MPa): Measured based on JIS K6251 (Dumbbell No. 3)

EB (elongation at break) (%): Measured based on JIS K6251 (Dumbbell No. 3)

TABLE I

| | Comparative | | | |
|---|---|---|---|---|
| | Example 1 | Example 4 | Example 5 | Example 6 |
| Formulation (parts by | | | | |
| weight) | | | | |
| IR*¹ | 100 | 100 | 100 | 100 |
| Carbon black*² | 50 | 50 | 50 | 50 |
| Antioxidant*³ | 1 | 1 | 1 | 1 |
| Zinc oxide*⁴ | 3 | 3 | 3 | 3 |
| Stearic acid*⁵ | 1 | 1 | 1 | 1 |
| Vulcanizing | 1 | 1 | 1 | 1 |
| accelerator (NS)*⁶ | | | | |
| Sulfur*⁷ | 1 | — | — | — |
| Cyclic polysulfide 1 | — | 3 | — | — |
| Cyclic polysulfide 2 | — | — | 3 | — |
| Cyclic polysulfide 3 | — | — | — | 3 |
| Evaluation of physical | | | | |
| properties | | | | |
| Tensile characteristics | | | | |
| (initial) | | | | |
| 100% modulus (MPa) | 1.94 | 1.97 | 1.95 | 2.01 |
| TB (MPa) | 25.08 | 27.50 | 28.20 | 27.05 |
| EB (%) | 569.0 | 575.5 | 588.3 | 572.3 |
| Tensile characteristics | | | | |
| (after aging at 100° C. | | | | |
| for 72 hours) | | | | |
| 100% modulus (MPa) | 2.85 | 2.79 | 2.70 | 2.83 |
| TB (MPa) | 19.28 | 24.25 | 25.30 | 23.95 |
| EB (%) | 402.3 | 439.5 | 450.3 | 437.5 |

Footnote for Table I
*¹Nipol IR2200 (Nippon Zeon polyisoprene)
*²Seast KH (Tokai Carbon)
*³Noccelar 224 (Ouchi Shinko Chemical Industrial)
*⁴Zinc White Special (Seido Chemical)
*⁵Luyac YA (NOF Corporation)
*⁶1N-t-butyl-2-benzothiazolyl sulfenamide
*⁷Sulfur powder (Karuizawa Refinery)
*⁸Polysulfide synthesized in Example 1
*⁹Polysulfide synthesized in Example 2
*¹⁰Polysulfide synthesized in Example 4

### INDUSTRIAL APPLICABILITY

According to the present invention, since the desired polysulfide compound can be produced under an anhydrous reaction condition at a good yield, when compounding the polysulfide compound thus produced into a rubber composition, there is extremely large practical value in terms of manufacturing work and manufacturing costs.

1. A method for producing a polysulfide compound comprising reacting a dihalogen compound having the following formula (I) and a metal polysulfide having the following formula (II):
X—R—X (I)
wherein X is a halogen and R is a C₂ to C₂₄ alkylene group, which may have a substituent or a hetero atom, or an aromatic alkylene group, and
M-Sx-M (II)
wherein M is a metal belonging to Group IA of the Periodic Table and x is an integer of an average 2 to 6 in an anhydrous solvent system.

2. A production method as claimed in claim 1, wherein the polysulfide obtained by the above reaction is a cyclic polysulfide having the formula (III): 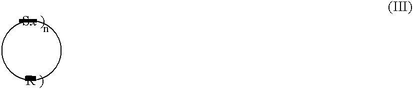
wherein R is as defined above, x is an integer of an average 2 to 6 and n is an integer of 1 to 30.

3. A production method as claimed in claim 1, wherein the solvent system is a mixed solvent system of a solvent in having a high solubility for the metal polysulfide and a solvent having a low solubility for the metal polysulfide.

4. A production method as claimed in claim 1, wherein the solvent having a high solubility for the metal polysulfide is an ether-based solvent and the solvent having a low solubility for the metal polysulfide is an aromatic hydrocarbon-based solvent.

5. A production method as claimed in claim 1, wherein a relative molar concentration (M) of the dihalogen compound to the reaction solvent is 10M or less at all times.

6. A rubber composition comprising 100 parts by weight of a vulcanizable rubber and 0.2 to 20 parts by weight of a polysulfide obtained by the method according to claim 1.
